(19) United States
(12) Patent Application Publication
(10) Pub. No.: US 2024/0300460 A1
(43) Pub. Date: Sep. 12, 2024

(54) TRAILER BRAKING CONTROL METHOD AND SYSTEM BASED ON ELECTRIC BRAKE CONTROLLER

(71) Applicant: Hubei Yuefeifan Automobile Technology Co., Ltd, Wuhan (CN)

(72) Inventors: Zhili Fan, Wuhan (CN); Jie Zou, Wuhan (CN); Qiang Jin, Wuhan (CN); Tao Yan, Wuhan (CN)

(21) Appl. No.: 18/670,030

(22) Filed: May 21, 2024

(30) Foreign Application Priority Data
Apr. 26, 2024 (CN) 202410510848.2

(51) Int. Cl. B60T 8/1755; B60T 8/171; B60T 8/58

(52) U.S. Cl. CPC B60T 8/17554; B60T 8/171; B60T 8/17551; B60T 8/58; B60T 2230/06; B60T 2250/02; B60T 2250/04

(57) ABSTRACT

The present disclosure discloses a trailer braking control method and system based on an electric brake controller. A lateral displacement and speed of a vehicle are acquired first; whether the vehicle has Death Wobble and a degree of the Death Wobble are then determined according to the lateral displacement; if there is Death Wobble, a driving state of the vehicle is determined according to the speed; and finally, a set voltage is added based on a set output voltage according to the degree of the Death Wobble and the driving state, so as to brake the vehicle. The present disclosure avoids setting of a weight ratio in the prior art to prevent the phenomenon of Death Wobble, and can identify and prevent the phenomenon of Death Wobble of a trailer, thereby avoiding an overturning accident and ensuring the personal safety and the integrity of a vehicle.

### TECHNICAL FIELD

The present disclosure relates to the technical field of trailer braking control, and in particular, to a trailer braking control method and system based on an electric brake controller.

### BACKGROUND

A centre-axle towing trailer, a recreational vehicle, and the like are unpowered vehicles that are towed by a front vehicle. A braking system of such a vehicle is generally classified into two types: a collision mitigation braking system and an electric brake system. The collision mitigation braking system achieves braking by impact of a trailer on a towing vehicle. Therefore, if an impact force of the trailer on the towing vehicle is higher, a braking force of the trailer is higher. A vehicle with the electric brake system is braked by pushing a brake pad by a suction force of an electromagnetic coil. Voltages applied to positive and negative electrodes of the electromagnetic coil are different, which determines different braking forces of the trailer. A higher voltage indicates a higher braking force. When the voltages constantly change, the braking force of the trailer will also constantly change.

When a vehicle runs at a high speed in a straight line, the vehicle may have “Death Wobble” in crosswind, during lane changing, or during overtaking (the vehicle does a snake-shaped, dramatic, high-frequency left-right yawing motion that may cause the vehicle to be out of control). If a trailer cannot actively brake and adjust its pose in a timely manner to quickly restore stability, the driver will not be able to correct a running trajectory of the trailer, and the trailer will lose control, leading to traffic accidents such as overturning.

In the prior art, a weight design is mainly carried out for the overall and internal layouts of trailers and recreational vehicles, making a front-rear weight ratio of the trailers more reasonable. This method is often used in the design stage of the recreational vehicles. However, in actual production and use processes, the front-rear weight ratio of the recreational vehicles may change. Moreover, when a towing vehicle is lighter than a trailer, high-speed driving may also lead to the phenomenon of Death Wobble. In addition, in an actual driving process, many other unknown factors may also lead to the phenomenon of yawing motion in a caravan, and counterweights can only reduce the probability of the yawing motion in the caravan, but cannot completely eliminate the yawing motion of the caravan.

Therefore, there is an urgent need for a trailer braking control method and system based on an electric brake controller to identify and prevent the phenomenon of “Death Wobble” of a trailer, thereby avoiding the occurrence of an overturning accident and ensuring the personal safety and the integrity of a vehicle.

### SUMMARY

By providing a trailer braking control method and system based on an electric brake controller, the present disclosures can identify and prevent the phenomenon of Death Wobble of a trailer, thereby avoiding an overturning accident and ensuring the personal safety and the integrity of a vehicle.

The present disclosure provides trailer braking control method based on an electric brake controller, including:
acquiring a lateral displacement and speed of a vehicle;
determining, according to the lateral displacement, whether the vehicle has Death Wobble and a degree of the Death Wobble;
if there is Death Wobble, determining a driving state of the vehicle according to the speed; and
adding a set voltage based on a set output voltage according to the degree of the Death Wobble and the driving state, so as to brake the vehicle.

Specifically, the determining, according to the lateral displacement, whether the vehicle has Death Wobble and a degree of the Death Wobble includes:
if the lateral displacement is bidirectionally reciprocating, determining that Death Wobble occurs; and
determining the degree of the Death Wobble according to a bidirectional reciprocating amount.

Specifically, the determining a driving state of the vehicle according to the speed includes:
determining, according to the speed, whether the driving state of the vehicle indicates a uniform motion, an accelerated motion, or a decelerated motion.

Specifically, before the adding a set voltage based on a set output voltage, the method further includes:
acquiring trailer weight data; and
determining the set output voltage according to the trailer weight data.

Specifically, the method further includes:
if there is no Death Wobble, outputting a real-time braking voltage according to different lateral displacements and a preset percentage of a braking voltage during straight driving.

The present disclosure further provides trailer braking control system based on an electric brake controller, including:
a data acquisition module, configured for acquiring a lateral displacement and speed of a vehicle;
a Death Wobble determining module, configured for determining, according to the lateral displacement, whether the vehicle has Death Wobble and a degree of the Death Wobble;
a driving state determining module, configured for: if there is Death Wobble, determining a driving state of the vehicle according to the speed; and
a braking control module, configured for adding a set voltage based on a set output voltage according to the degree of the Death Wobble and the driving state, so as to brake the vehicle.

Specifically, the Death Wobble determining module includes:
a Death Wobble determining unit, configured for: if the lateral displacement is bidirectionally reciprocating, determining that Death Wobble occurs; and
a Death Wobble degree determining unit, configured for determining the degree of the Death Wobble according to a bidirectional reciprocating amount.

Specifically, the driving state determining module is specifically configured for determining, according to the speed, whether the driving state of the vehicle indicates a uniform motion, an accelerated motion, or a decelerated motion.

Specifically, the system further includes:
a trailer weight acquisition module, configured for acquiring trailer weight data; and
a set output voltage determining module, configured for determining the set output voltage according to the trailer weight data.

Specifically, the system further includes:
a braking voltage outputting module, configured for: if there is no Death Wobble, outputting a real-time braking voltage according to different lateral displacements and a preset percentage of a braking voltage during straight driving.

One or more of the above technical solutions of the present disclosure at least have the following technical effects or advantages:

A lateral displacement and speed of a vehicle are acquired first; whether the vehicle has Death Wobble and a degree of the Death Wobble are then determined according to the lateral displacement; if there is Death Wobble, a driving state of the vehicle is determined according to the speed; and finally, a set voltage is added based on a set output voltage according to the degree of the Death Wobble and the driving state, so as to brake the vehicle. The present disclosure avoids setting of a weight ratio in the prior art to prevent the phenomenon of Death Wobble, and can identify and prevent the phenomenon of Death Wobble of a trailer, thereby avoiding an overturning accident and ensuring the personal safety and the integrity of a vehicle.

### BRIEF DESCRIPTION OF THE DRAWINGS

FIG. 1 is a flowchart of a trailer braking control method based on an electric brake controller according to an embodiment of the present disclosure;

FIG. 2 is a schematic diagram of a trailer braking control method based on an electric brake controller according to an embodiment of the present disclosure;

FIG. 3 is a schematic diagram of detected values of a lateral axis of a sensor in a trailer braking control method based on an electric brake controller according to an embodiment of the present disclosure; and

FIG. 4 is a module diagram of a trailer braking control system based on an electric brake controller according to an embodiment of the present disclosure.

### DETAILED DESCRIPTION OF THE EMBODIMENTS

By providing a trailer braking control method and system based on an electric brake controller, the embodiments of the present disclosures can identify and prevent the phenomenon of Death Wobble of a trailer, thereby avoiding an overturning accident and ensuring the personal safety and the integrity of a vehicle.

In order to better understand the above technical solutions, the above technical solutions will be explained in detail below in conjunction with the accompanying drawings of this specification and the specific implementations.

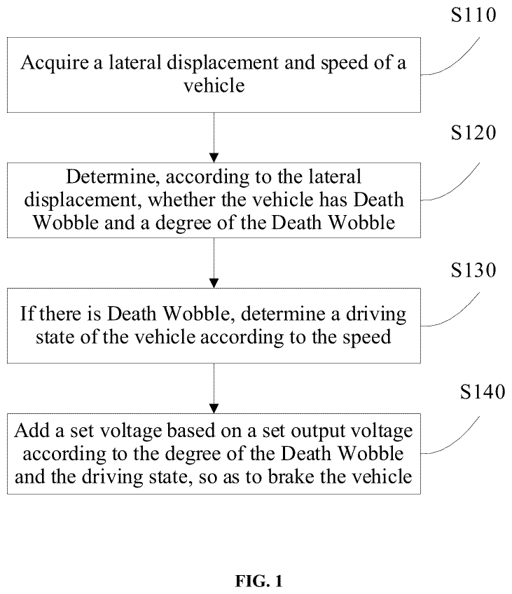

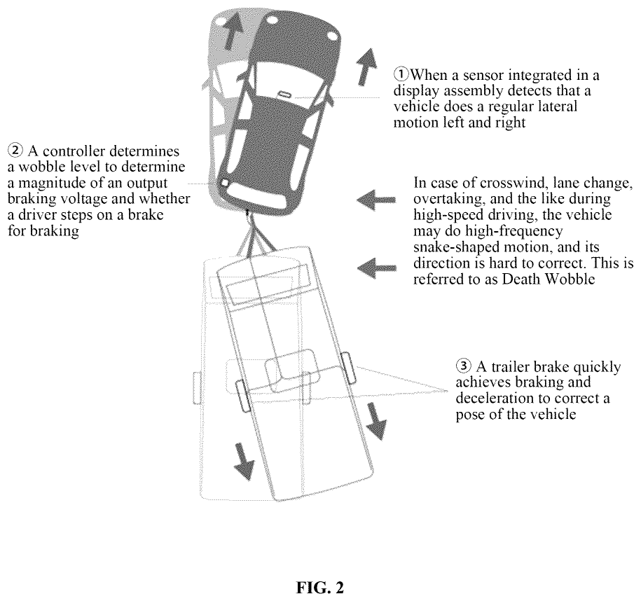

Referring to FIG. 1 and FIG. 2, a trailer braking control method based on an electric brake controller according to an embodiment of the present disclosure is shown, including:

Step S110: A lateral displacement and speed of a vehicle are acquired.

Specifically, in the embodiments of the present disclosure, an electric brake controller screen integrated with a sensor and an electric brake controller host unit MCU integrated with a sensor are included and perform communication transmission by a TYPE-C data wire. The electric brake controller screen is mounted on a windshield of a towing vehicle, and the electric brake controller host unit MCU is mounted at a tail portion of the towing vehicle.

A main core assembly of the electric brake controller screen is composed of a color liquid crystal display screen, five physical buttons, a power supply chip, a single-chip microcomputer, an encryption chip, a sensor, a plurality of communication chips, and the like.

The following information can be provided for a user through the display screen:
I. Trailer state information (such as: a trailer has been connected, a trailer has been disconnected, a trailer has a short circuit, power loss, and low power, and the like).
II. The display screen further displays a real-time braking output force during braking (such as: a real-time braking output force scroll bar and a voltage magnitude value).

### III. Working State

A user can set some of the following parameters in a host box of the controller through buttons:
A. Adjust the maximum braking output force (freely within a range of 0 V to 14 V);
B. Adjust the output reaction sensitivity (within a 9-level range from S1 to S9);
C. Set languages
D. Set brightness
E. Set standby time
F. Set Bluetooth
G. Set a vehicle inspection mode
H. Set a manual braking speed
I. Manual braking.

The sensor integrated in the display assembly is used to detect lateral motion data of the vehicle, so as to provide a standard and basis for determining Death Wobble for the brake controller.

A main core assembly of the electric brake controller host unit MCU is composed of a power supply chip, a single-chip microcomputer, a sensor, a storage chip, an encryption chip, a plurality of communication chips, a plurality of driver chips, and the like.

The host box has two interfaces: One interface is a power interface, which is electrically connected to the vehicle and has a power input, a braking signal input, and a braking voltage output. The other interface is a communication interface. The communication interface is connected to a communication interface of the display and provides power to the display and achieves exchange of data between the host box and the display.

The sensor integrated in the host box assembly is used to detect data of a vehicle speed Gdate and provides a basis for the trailer to assist in the towing vehicle in the braking force.

The single-chip microcomputer of the host box performs calculation and processing on the data acquired by the sensor, adjusts a pulse width modulation (PMW) output duty cycle of the driver chip, synchronously coordinates an electric brake system, and maintains a consistent braking force between the trailer and the towing vehicle to achieve a balanced braking effect.

Step S120: Whether the vehicle has Death Wobble and a degree of the Death Wobble are determining according to the lateral displacement.

This step is specifically explained. Whether the vehicle has Death Wobble and a degree of the Death Wobble are determined according to the lateral displacement, which includes:

If the lateral displacement is bidirectionally reciprocating, it is determined that Death Wobble occurs.

The degree of the Death Wobble is determined according to a bidirectional reciprocating amount.

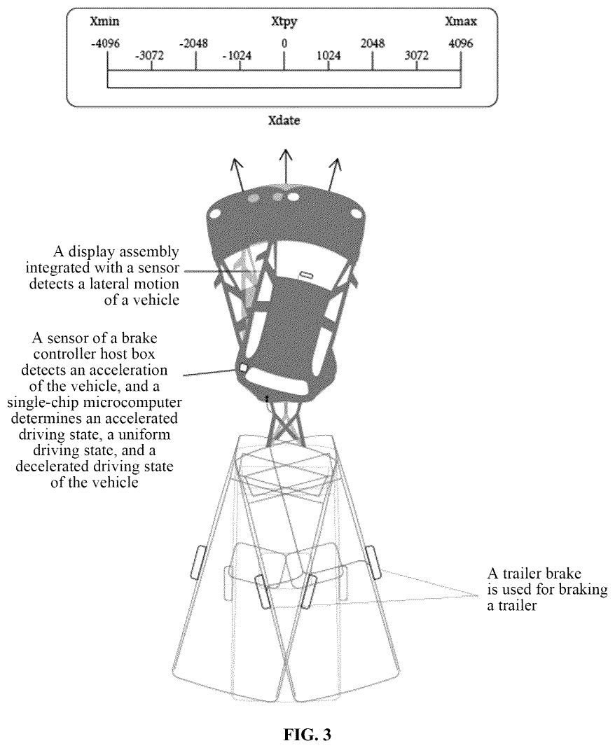

Referring to FIG. 3, the standard for determining the degree of the Death Wobble according to the lateral displacement (date value) detected by the sensor of the display within specified time and the speed G value detected by the sensor of the controller host is as follows:

Mild wobble:
1. If a value changes from a current value to Xdate+128, and then from Xdate+128 to Xdate-128, namely, the vehicle first moves to the right and then to the left regularly.
2. If a value changes from a current value to Xdate-128, and then from Xdate-128 to Xdate+128, namely, the vehicle first moves to the left and then to the right regularly.

Moderate wobble:
1. If a value changes from a current value to Xdate+128+64, and then from Xdate +128+64 to Xdate −128-64, namely, the vehicle first moves to the right and then to the left regularly.
2. If a value changes from a current value to Xdate −128-64, and then from Xdate −128-64 to Xdate+128+64, namely, the vehicle first moves to the left and then to the right regularly.

Severe wobble:
1. If a value changes from a current value to Xdate+128+64+64, and then from Xdate+128+64+64 to Xdate −128-64-64, namely, the vehicle first moves to the right and then to the left regularly.
2. If a value changes from a current value to Xdate-128-64-64, and then from Xdate −128-64-64 to Xdate+128+64+64, namely, the vehicle first moves to the left and then to the right regularly.

Step S130: If there is Death Wobble, a driving state of the vehicle is determined according to the speed.

Specifically, a driving state of the vehicle is determined according to the speed, which includes:

Whether the driving state of the vehicle indicates a uniform motion, an accelerated motion, or a decelerated motion is determined according to the speed.

Step S140: A set voltage is added based on a set output voltage according to the degree of the Death Wobble and the driving state, so as to brake the vehicle.

Specifically, when the vehicle is deemed to be in a wobble state, the controller host may actively output a voltage to brake the trailer no matter whether the driver steps on a brake.

When the vehicle is in the mild wobble state and the driving state indicates the decelerated motion or the uniform motion, the voltage output by the controller is: Output braking voltage OutputV=Set maximum braking voltage SetmaxV pPower voltage PowerV, that is, the set voltage is output for braking. If the vehicle is the accelerated state, the voltage output by the controller is: OutputV=SetmaxV+SetmaxV×10%≤PowerV, that is, a 10% voltage is added based on the set output voltage to brake the trailer.

When the vehicle is in the mild wobble state and the driving state indicates the decelerated motion or the uniform motion, the voltage output by the controller is: OutputV=SetmaxV+SetmaxV×10%≤PowerV, that is, a 10% voltage is added based on the set output voltage to brake the trailer. If the vehicle is the accelerated state, the voltage output by the controller is: OutputV=SetmaxV+SetmaxV×15%≤PowerV, that is, a 15% voltage is added based on the set output voltage to brake the trailer.

When the vehicle is in the severe wobble state and the driving state indicates the decelerated motion or the uniform motion, the voltage output by the controller is: OutputV=SetmaxV+SetmaxV×15%≤−PowerV, that is, a 15% voltage is added based on the set output voltage to brake the trailer. If the vehicle is the accelerated state, the voltage output by the controller is: OutputV=SetmaxV+SetmaxV×20%≤−PowerV, that is, a 20% voltage is added based on the set output voltage to brake the trailer.

To be able to increase braking speeds of trailers with different weights to prevent overturning of the trailers, before a set voltage is added based on a set output voltage, the method further includes:

Trailer weight data is acquired.

The set output voltage is determined according to the trailer weight data.

That is, the set output voltage corresponding to the trailers with different weights varies. In this embodiment, a heavier trailer corresponds to a higher set output voltage.

In the braking control process, a wobble warning icon and a screen prompt “Slow down. Caution”. An exit condition for the braking control is that the value detected by Xdate is within ±64 and no longer changes regularly. The controller exits a wobble correction program, and the driver controls the braking of the vehicle. If the driver still steps on a brake pedal at this time, braking is achieved according to the data acquired by the sensor. If the driver does not step on the brake pedal, the controller may stop outputting the braking voltage, and correction of the wobble prevention operation is completed.

In order to reduce the towing sensation of the trailer during turning and prevent side tumbling of the trailer, the method further includes:

If there is no Death Wobble, a real-time braking voltage is output according to different lateral displacements and a preset percentage of a braking voltage during straight driving.

Specifically, in the embodiments of the present disclosure, the value Xdate of the lateral displacement sensor of the display is used as a basis. When the vehicle turns to the left, a value changes from a current value Xdate to −4096 according to a value Xdate of a turning angle, namely, Xdate −N−4096. When the vehicle turns to the right, a value changes from a current value Xdate to +4096 according to a value Xdate of a turning angle, namely, Xdate+N+4096.

In this embodiment, in case of Xdate (±4096)>(±2048), OutputV=SetmaxV×0.7÷Gdate, that is, the real-time braking voltage is output according to 70% of the braking voltage during the straight driving. In case of Xdate (±2048)>(±1024), OutputV=SetmaxV×0.85÷Gdate, that is, the real-time braking voltage is output according to 85% of the braking voltage during the straight driving; and in case of Xdate<(±1024), OutputV=SetmaxV÷Gdate, that is, the real-time braking voltage is output according to 100% of the braking voltage during the straight driving

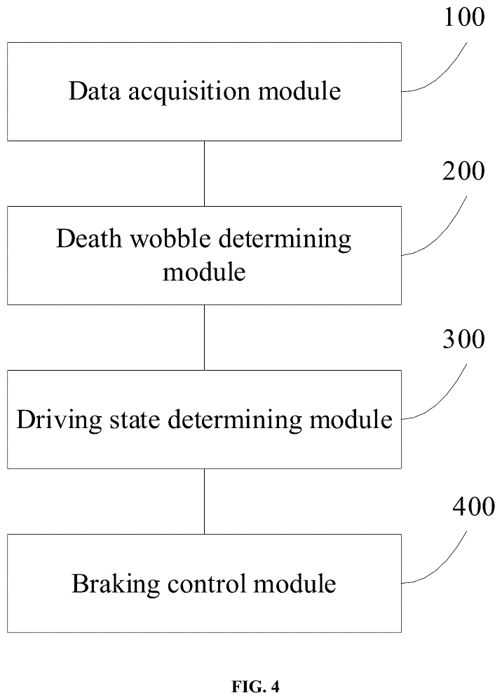

Referring to FIG. 4, a trailer braking control system based on an electric brake controller according to an embodiment of the present disclosure is shown, including:
a data acquisition module 100, configured for acquiring a lateral displacement and speed of a vehicle;
a Death Wobble determining module 200, configured for determining, according to the lateral displacement, whether the vehicle has Death Wobble and a degree of the Death Wobble;
wherein specifically, the Death Wobble determining module 200 includes:
a Death Wobble determining unit, configured for: if the lateral displacement is bidirectionally reciprocating, determining that Death Wobble occurs; and
a Death Wobble degree determining unit, configured for determining the degree of the Death Wobble according to a bidirectional reciprocating amount;
a driving state determining module 300, configured for: if there is Death Wobble, determining a driving state of the vehicle according to the speed;
wherein specifically, the driving state determining module 300 is specifically configured for determining, according to the speed, whether the driving state of the vehicle indicates a uniform motion, an accelerated motion, or a decelerated motion; and
a braking control module 400, configured for adding a set voltage based on a set output voltage according to the degree of the Death Wobble and the driving state, so as to brake the vehicle.

To be able to increase braking speeds of trailers with different weights to prevent overturning of the trailers, the system further includes:
a trailer weight acquisition module, configured for acquiring trailer weight data; and
a set output voltage determining module, configured for determining the set output voltage according to the trailer weight data.

That is, the set output voltage corresponding to the trailers with different weights varies. In this embodiment, a heavier trailer corresponds to a higher set output voltage.

In order to reduce the towing sensation of the trailer during turning and prevent side tumbling of the trailer, the method further includes:
a braking voltage outputting module, configured for: if there is no Death Wobble, outputting a real-time braking voltage according to different lateral displacements and a preset percentage of a braking voltage during straight driving.

The embodiments of the present disclosure avoids setting of a weight ratio in the prior art to prevent the phenomenon of Death Wobble, and can identify and prevent the phenomenon of Death Wobble of a trailer, thereby avoiding an overturning accident and ensuring the personal safety and the integrity of a vehicle.

Those skilled in the art should understand that the embodiments of the present disclosure may be methods, systems or computer program products. Therefore, the present disclosure may adopt the form of a complete hardware embodiment, a complete software embodiment, or a software and hardware combination embodiment. In addition, the present disclosure may adopt the form of a computer program product implemented on one or multiple computer-sensitive storage media (including, but not limited to, a magnetic disk memory, a compact disc read-only memory (CD-ROM), an optical memory and the like) including computer-sensitive program codes.

The present disclosure is described by referring to flowcharts and/or block diagrams of methods, devices (systems) and computer program products according to the embodiments of the present disclosure. It is worthwhile to note that computer program instructions can be used to implement each flow and/or each block in the flowcharts and/or the block diagrams and a combination of a flow and/or a block in the flowcharts and/or the block diagrams. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more flows in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more flows in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more flows in the flowcharts and/or in one or more blocks in the block diagrams.

Any aspects that are not described in detail in the embodiments of the present disclosure are well-known technologies to those skilled in the art. Finally, it should be noted that the above embodiments are only used to explain the technical solutions of the present disclosure and not intended to limit the technical solutions. Although the present disclosure has been described in detail with reference to the preferred embodiments, those of ordinary skill in the art should understand that the technical solutions of the present disclosure can be modified or equivalently replaced without departing from the purpose and scope of the technical solutions of the present disclosure, which should fall within the scope of the claims of the present disclosure.

What is claimed is:

1. A trailer braking control method based on an electric brake controller, comprising:
acquiring a lateral displacement and speed of a vehicle;
determining, according to the lateral displacement, whether the vehicle has Death Wobble and a degree of the Death Wobble;
if there is Death Wobble, determining a driving state of the vehicle according to the speed; and
adding a set voltage based on a set output voltage according to the degree of the Death Wobble and the driving state, so as to brake the vehicle.

2. The trailer braking control method based on the electric brake controller according to claim 1, wherein the determining, according to the lateral displacement, whether the vehicle has Death Wobble and a degree of the Death Wobble comprises:
if the lateral displacement is bidirectionally reciprocating, determining that Death Wobble occurs; and
determining the degree of the Death Wobble according to a bidirectional reciprocating amount.

3. The trailer braking control method based on the electric brake controller according to claim 1, wherein the determining a driving state of the vehicle according to the speed comprises:
determining, according to the speed, whether the driving state of the vehicle indicates a uniform motion, an accelerated motion, or a decelerated motion.

4. The trailer braking control method based on the electric brake controller according to claim 1, wherein before the adding a set voltage based on a set output voltage, the method further comprises:
acquiring trailer weight data; and
determining the set output voltage according to the trailer weight data.

5. The trailer braking control method based on the electric brake controller according to claim 1, further comprising:
if there is no Death Wobble, outputting a real-time braking voltage according to different lateral displacements and a preset percentage of a braking voltage during straight driving.

6. A trailer braking control system based on an electric brake controller, comprising:
a data acquisition module, configured for acquiring a lateral displacement and speed of a vehicle;
a Death Wobble determining module, configured for determining, according to the lateral displacement, whether the vehicle has Death Wobble and a degree of the Death Wobble;
a driving state determining module, configured for: if there is Death Wobble, determining a driving state of the vehicle according to the speed; and
a braking control module, configured for adding a set voltage based on a set output voltage according to the degree of the Death Wobble and the driving state, so as to brake the vehicle.

7. The trailer braking control system based on the electric brake controller claim 6, wherein the Death Wobble determining module comprises:
a Death Wobble determining unit, configured for: if the lateral displacement is bidirectionally reciprocating, determining that Death Wobble occurs; and
a Death Wobble degree determining unit, configured for determining the degree of the Death Wobble according to a bidirectional reciprocating amount.

8. The trailer braking control system based on the electric brake controller according to claim 6, wherein the driving state determining module is specifically configured for determining, according to the speed, whether the driving state of the vehicle indicates a uniform motion, an accelerated motion, or a decelerated motion.

9. The trailer braking control system based on the electric brake controller according to claim 6, further comprising:
a trailer weight acquisition module, configured for acquiring trailer weight data; and
a set output voltage determining module, configured for determining the set output voltage according to the trailer weight data.

10. The trailer braking control system based on the electric brake controller according to claim 6, further comprising:
a braking voltage outputting module, configured for: if there is no Death Wobble, outputting a real-time braking voltage according to different lateral displacements and a preset percentage of a braking voltage during straight driving.
